(19) United States
(12) Patent Application Publication
(10) Pub. No.: US 2014/0159868 A1
(43) Pub. Date: Jun. 12, 2014

(54) Address display and emergency alert device

(71) Applicants: Eddie Sanders, Chicago, IL (US); Harold Psalms, Blue Island, IL (US)

(72) Inventors: Eddie Sanders, Chicago, IL (US); Harold Psalms, Blue Island, IL (US)

(21) Appl. No.: 13/860,069

(22) Filed: Apr. 10, 2013

Related U.S. Application Data
(63) Continuation-in-part of application No. 29/401,051, filed on Sep. 6, 2011, now Pat. No. D680172.

(51) Int. Cl. G08B 5/22; G08B 5/38

(52) U.S. Cl. CPC G08B 5/224; G08B 5/38
USPC 340/7.61

(57) ABSTRACT

A lighted address display system that can be programmed to display a street address on a house or building. The normal state is a solid color preferably white. An wireless alert from the address display that can be tied to an alarm system, emergency alert system, fire, CO2 or gas alarms causes the display to change color (to red for example) and typically blink. This draws immediate attention to the fact that there is some sort of emergency situation in the house or building.

### BACKGROUND

This is a continuation-in-part of design application Ser. No. 29/401,051 filed Sep. 6, 2011 to be U.S. Pat. No. D680,172. Application Ser. No. 29/401,051 is hereby incorporated by reference in its entirety.

### FIELD OF THE INVENTION

The present invention relates generally to lighted address displays and more particularly to an address display that can also act as an emergency alert device.

### DESCRIPTION OF THE PRIOR ART

Lighted address displays for houses and buildings are known in the art. The first inventor's U.S. Pat. No. 6,568,109 is an example. These displays can be programmed to display a lighted address on a house or building. Prior art address displays either used lighted programmable digits or carved out address digits with lights behind a carved template.

Building alarm systems are also well-known in the art. Several companies such as ADT and others supply complete residential and commercial barrier alarm systems. Such alarm systems report intrusions by silent telephone or other communications with an alarm center or with the police. In addition, depending upon the system, an annunciator or siren can create a loud audible alarm. Many alarm systems time out if there is no response after a predetermined time.

Emergency alert systems like those supplied under the name First Alert (TM) are popular with the elderly. handicapped or others who may live alone. These immediately alert a center or the police upon pressing a button.

There is no prior art system that combines all these features. It would be advantageous to have a lighted address system that could change color and/or blink if a building alarm system or an emergency alert is activated.

### SUMMARY OF THE INVENTION

The present invention relates to a lighted address display system that can be programmed to display a street address on a house or building. The normal state is a solid color preferably white. An wireless alert from the address display that can be tied to an alarm system, emergency alert system, fire, CO2 or gas alarms causes the display to change color (to red for example) and typically blink. This draws immediate attention to the fact that there is some sort of emergency situation in the house or building.

### DESCRIPTION OF THE FIGURES

Several figures are presented to illustrate features of the present invention.

FIG. 1 shows a perspective view of an embodiment of the present invention.

FIG. 2 shows a block diagram of an embodiment of the present invention.

FIG. 3 shows a diagram of the present invention coupled to an alarm and emergency alert system.

FIG. 4 is a flow chart of typical action taken by the present invention.

Several drawings and illustrations have been presented to aid in understanding the present invention. The scope of the present invention is not limited to what is shown in the figures.

### DESCRIPTION OF THE INVENTION

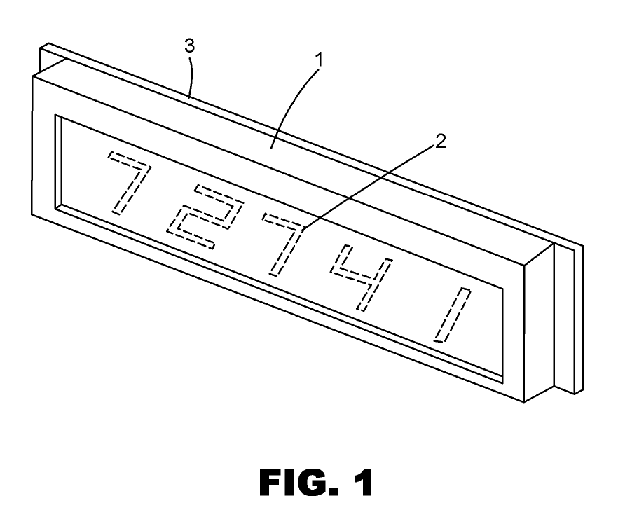

The present invention relates to a lighted address display system that can be wirelessly coupled to either or both an alarm system and an emergency alert system. The display shown in FIG. 1 is in an enclosure 1 and can be located on the outside of a building or in a window. Programmable digits 2 can be set to display the address. In this mode, the present invention functions similar to prior art systems in that it displays the address to passerby's or to anyone approaching the building. It has been found, that while any color can be used, the most visible and easily used for normal address display operation is white. White programmable digits are preferred. Switches (not shown) can be used to program the correct address. Once these are adjusted, they are usually not changed. For this reason, they can be located either on the back 3 of the enclosure 1 or inside.

The digits 2 according to the present invention can be of the type known in the art that can change color under electronic control. In addition, they can be made to blink by sequentially applying and removing power to them. The preferred colors are white for normal operation and red for emergency indication. While these colors are preferred, any choice or combination of colors is within the scope of the present invention.

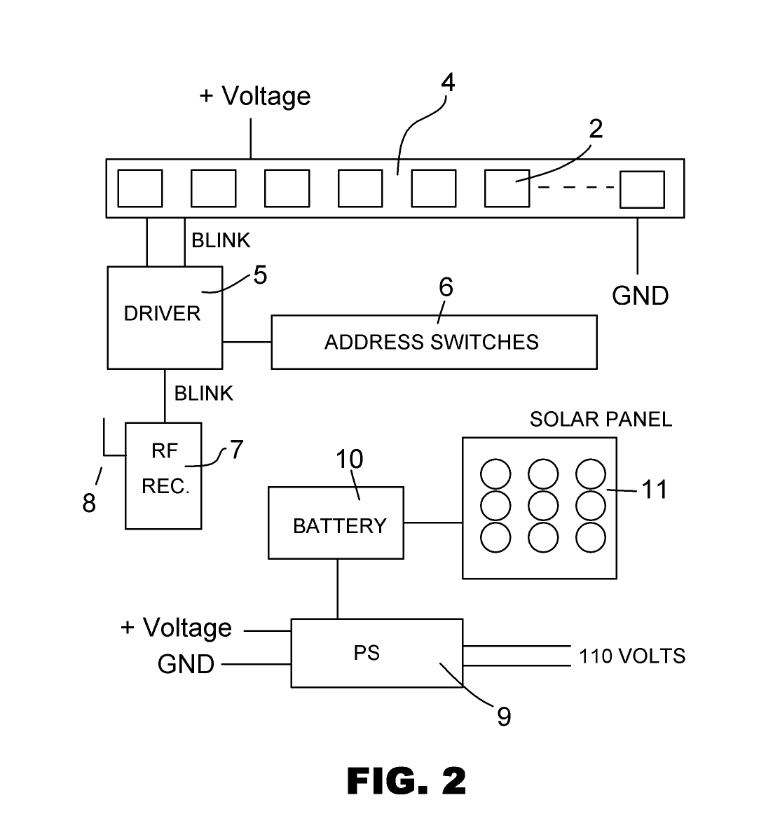

FIG. 2 shows a block diagram of an embodiment of the present invention. A row 4 of digits 2 are supplied with a voltage and are driven by a driver circuit. The driver circuit can cause the digits 2 to stay on with steady output or to blink according to a blink timer (not shown) that can be made from counters known in the art. In addition, the driver circuit 5 can make the digits 2 blink. Typical digits are semi-conductor packages containing light emitting diodes (LEDs) or any other light sources. They can be programmed to display numbers and optionally, alpha-numerics.

A set of address switches 6 can be used to set what number or alpha-numeric each digit 2 displays. The user typically sets the switches 6 to display a street address on the row 4 of digits 2; however, any other information may be displayed.

A radio frequency (RF) receiver 7 has an antenna 8 and can receive a coded RF signal from a remote FOB or transmitter as is known in the art. Coding prevents nearby similar transmitters from interfering. When the RF receiver 7 reports that it has received a signal, either from a building alarm being tripped, or from an emergency alert system, the driver 5 causes the digits 2 to change color and usually also to blink. The most common use would be to display an address in white in a normal state, and to change to blinking red in an emergency state. While this is the preferred mode of operation, any other mode is within the scope of the present invention.

Power is supplied to the unit from a power supply 9 that can be powered from 110 volt (or other voltage) building mains, and can be optionally powered from a backup battery 10. The battery 10 can be optionally charged from a solar panel 11. Various embodiments of the present invention can be made that do not have a solar panel.

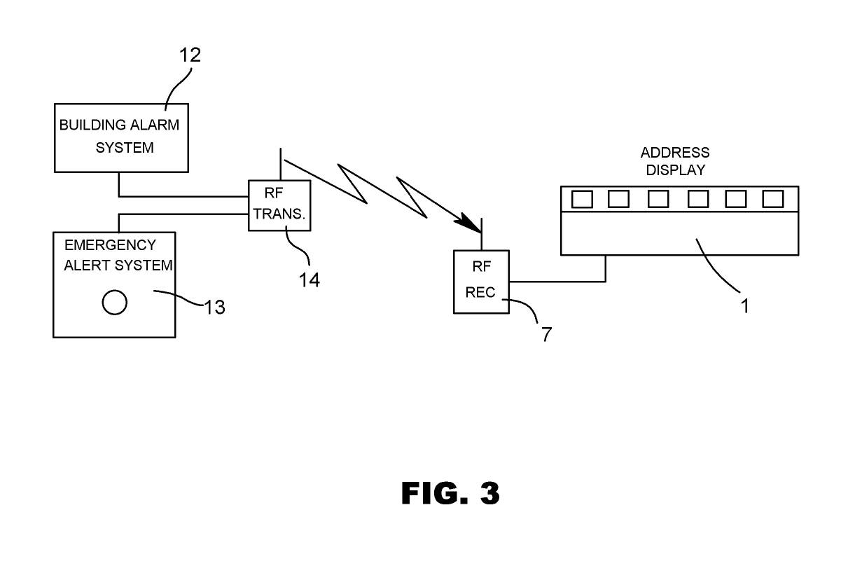

FIG. 3 shows the address display of the present invention 1 with its RF receiver 7 wirelessly coupled to a building alarm system 12 and/or an emergency alert system 13 by an RF transmitter 14. When an emergency event occurs such as the alarm system triggering or the emergency alert system being activated, the RF transmitter 14 sends a wireless, typically coded, signal to the RF receiver 7 which then causes the display 1 to change color and/or blink.

While the preferred embodiment uses one-way wireless communications, it is also possible to use two-way communications to feed back state and status information to a remote controller (not shown) or to the alarm system 12 or the alert system 13. Also, while RF is the preferred mode of wireless communication (similar to garage door openers), it is within the scope of the present invention to use any wireless technique including WiFi, infra-red, cellular telephone, or any other wireless communication technique.

The embodiments shown in the figures do not typically need to contain a microcontroller or microprocessor; however, it is within the scope of the present invention to also contain any type of programmable controller with memory and executable instructions.

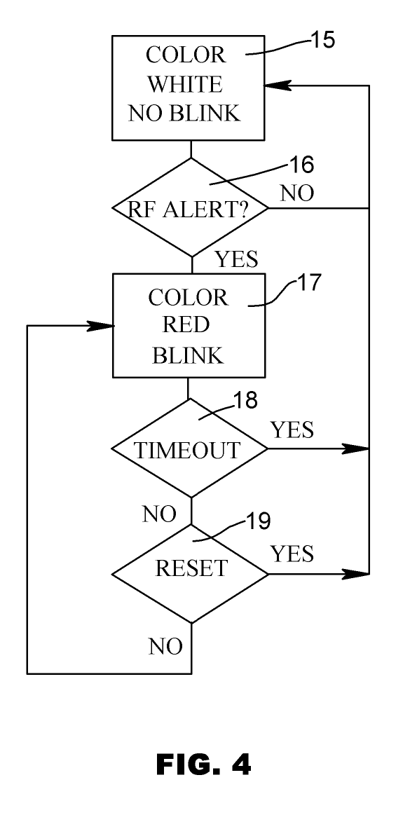

FIG. 4 shows a flow diagram of a typical operating sequence for embodiments of the present invention. In a normal state 15, the color of the address digits is white, and they are not blinking. The system tests 16 for an incoming wireless alert. If none is detected, the system stays in the normal state 15. However, upon reception of a wireless alert, emergency state 17 is entered. In this example, the color is changed to red, and the digits are made to blink. The blink rate can be several times per second to attract attention to the display. While this is a preferred blink rate, any blink rate is within the scope of the present invention. Even if the wireless alert disappears, the system is latched in the emergency state 17 (using a D-flip flop or any other latching technique known in the art including a software latch).

While latched in the emergency state 17, the system test 18 for a time out. A timer known in the art can be set to any value. A preferred value is at least an hour or two so that the emergency display indication is not reset before it can be noticed. This reset timeout can be predetermined at the time of manufacture, or it can be user programmable. If a timeout occurs, the system is returned to the normal state 15.

While in the emergency state 17, the system also tests 19 for a manual reset. If a manual reset is detected, the system returns to the normal state 15.

The RF transmitter 14 and receiver 7 can be off-the-shelf FOB or other RF units. The programmable digits can be two-color integrated circuit display digits known in the art. Timers can be made from chains of digital counters driven by a clock signal as is known in the art. Latching can be by any switching means including flip-flops and other bistable devices known in the art.

As previously stated, bi-directional communications can be used to report a tripped or normal status to a remote station. Any other system parameter can also be so reported.

The housing of the display 1 should be waterproof and conditioned for outdoor mounting. Display brightness can be optionally automatically or manually modulated for different levels of ambient light as is known in the art.

The present invention provides normal address display reporting so that seekers can find an address, especially at night. In addition, it provides a visual indication of an emergency situation in the building such as a tripped alarm or other emergency. The present invention can be tied to fire, CO2, gas leakage or any other emergency system to provide a direct visual indication to passersby and first responders of abnormal conditions. The difference between a solid, neutral white address display and a blinking red display is striking and immediately calls attention to the situation.

While wireless communication is the preferred method of receiving an alert form an alarm or alert system, it is within the scope of the present invention to use hard wire.

Several descriptions and illustrations have been presented that aid in understanding the present invention. One with skill in the art will realize that numerous changes may be made without departing from the spirit of the invention. Each of these changes and variations is within the scope of the present invention.

We claim:

1. An address display and alert system comprising:
a plurality of programmable, lighted numeric or alphanumeric digits adapted to display an address;
a wireless interface adapted to be coupled to an alarm or alert system;
a first control circuit adapted to cause said display to blink when said wireless interface receives an indication of an alert.

2. The address display and alert system of claim 1 further comprising a second control circuit adapted to cause said plurality of programmable, lighted numeric or alphanumeric digits to change color when said wireless interface receives said indication of an alert.

3. The address display of claim 2 wherein said system displays said address in white during normal operation and in red in emergency operation.

4. The address display of claim 1 wherein said first control circuit is adapted to cause said display to stop blinking after a predetermined period without alerts from said wireless interface.

5. The address display of claim 2 wherein said first control circuit is adapted to cause said display to again change color after a predetermined period without alerts from said wireless interface.

6. The address display of claim 1 wherein said wireless interface if radio.

7. An address display and alert system comprising:
a plurality of programmable, lighted numeric or alphanumeric digits adapted to display an address;
a wireless interface adapted to be coupled to an alarm or alert system;
a first control circuit adapted to cause said display to change color when said wireless interface receives an indication of an alert.

8. The address display and alert system of claim 7 further comprising a second control circuit adapted to cause said plurality of programmable, lighted numeric or alphanumeric digits to blink when said wireless interface receives said indication of an alert.

9. The address display of claim 7 wherein said system displays said address in white during normal operation and in red in emergency operation.

10. The address display of claim 7 wherein said first control circuit is adapted to cause said display to again change color after a predetermined period without alerts from said wireless interface.

11. The address display of claim 8 wherein said first control circuit is adapted to cause said display to stop blinking after a predetermined period without alerts from said wireless interface.

12. The address display of claim 7 wherein said wireless interface is radio.

13. An address display and alert system comprising:
a plurality of programmable, lighted numeric or alphanumeric digits adapted to display an address in a non-blinking first color;
a wireless interface adapted to be coupled to an alarm or alert system;
a control circuit adapted to cause said display to change color to a second color and to blink when said wireless interface receives an indication of an alert.

14. The address display and alert system of claim 13 wherein said first color is white and said second color is red.

15. The address display of claim 13 wherein said control circuit is adapted to cause said display to change color to said first color and stop blinking after a predetermined period without alerts from said wireless interface.

16. The address display of claim 13 wherein said control circuit is adapted to cause said display to change color to said first color and stop blinking after manual reset.
